(19) United States
(12) Patent Application Publication
(10) Pub. No.: US 2020/0262464 A1
(43) Pub. Date: Aug. 20, 2020

(54) ROCKING DEVICE

(71) Applicant: Sapsway S.R.O., Jablonec nad Nisou (CZ)

(72) Inventors: Jiri Salaba, Jablonec nad Nisou (CZ); Lukás Patocka, Vysoke nad Jizerou (CZ)

(73) Assignee: Sapsway S.R.O., Jablonec nad Nisou (CZ)

(21) Appl. No.: 16/063,796

(22) PCT Filed: Dec. 7, 2016
(86) PCT No.: PCT/CZ2016/000128

§ 371 Date: Jun. 19, 2018

(30) Foreign Application Priority Data
Dec. 20, 2015 (CZ) PUV 2015-31925

(51) Int. Cl. B62B 9/22; A47D 9/02

(52) U.S. Cl. CPC B62B 9/22; B62B 2202/42; A47D 9/02

(57) ABSTRACT

The device consists of a base plate in which there are formed rails, in which there is placed the travel on the wheels. The travel is connected with an electric motor fastened also to the base plate, which ensures the movement of the travel. The transfer of the rotational movement of the electric motor into linear movement of the reciprocating to the travel is achieved by thanks to the crank mechanism. One side of the crank is rigidly connected with an electric motor, the other side is fixed to the travel. To the travel there is fixed the wheel of a stroller or crib, using demountable joint (fit). An important part of the device are the upper rails, which prevent from the vertical movement of the travel and thus allow only horizontal movement.

### TECHNICAL FIELD

The technical solution relates to the design of the device, which allows you to swing mainly all types of strollers and cribs.

### BACKGROUND ART

Up to now, for the rocking and lulling the children in the stroller or in the crib a manual force or some already known design are predominantly used. State of the art in this field is shown by technical solutions such as CN201685865U, CN202994426U, CN2551118Y. The disadvantage of these structures are the great dimensions and often complicated structure of the whole device, and also the mobility of the device.

### DISCLOSURE OF THE INVENTION

The task of the technical solution is the project of a new structure of the device for rocking of a great range of strollers and cribs.

The device consists of a base plate in which there are formed rails, in which there is placed the travel on the wheels. The travel is connected with an electric motor fastened also to the base plate, which ensures the movement of the travel. The transfer of the rotational movement of the electric motor into linear movement of the reciprocating to the travel is achieved by thanks to the crank mechanism. One side of the crank is rigidly connected with an electric motor, the other side is fixed to the travel. To the travel there is fixed the wheel of a stroller or crib, using demountable joint (fit). An important part of the device are the upper rails, which prevent from the vertical movement of the travel and thus allow only horizontal movement.

Undoubtedly, the biggest advantage is the versatility, thanks to which we can use the device, understood as an external element, to a large number of different types of strollers and cribs, as compared to the structures above. The location under the wheels is simple and ensures easy installation. Transfer of the part of the weight of the stroller or the crib on the device ensures its stability in terms of the driving force in their movement.

Its operation in the home is advantageous when it is plugged into the mains, but also in outdoor areas, thanks to the battery that can be part of the device. Smooth and quiet operation is secured by using the alternating/direct electric motor.

Also its controller is appropriate, that allows the change of the size of the revolutions per minute of the power unit, and thus also the movement of the stroller or the crib at different speeds.

The device can be controlled manually directly in the stroller or the crib, but also by using the remote control, and/or mobile phone (bluetooth, wifi), which is also another great advantage.

Particularly advantageous is the possibility to start the music using the integrated player, which sweetens the sleep of the child.

As a practical solution we can state the structure of the balance pad, which is inserted under the second wheel of the stroller or the crib, which ensures the coaxiality of the two front or rear wheels. Thanks to its different shape and the surface the straight or general movement of the stroller or the crib is possible.

### BRIEF DESCRIPTION OF THE DRAWINGS

The structure of a universal rocking device for strollers or the cribs will be explained using images, where

FIG. 1 shows the placing with the stroller,

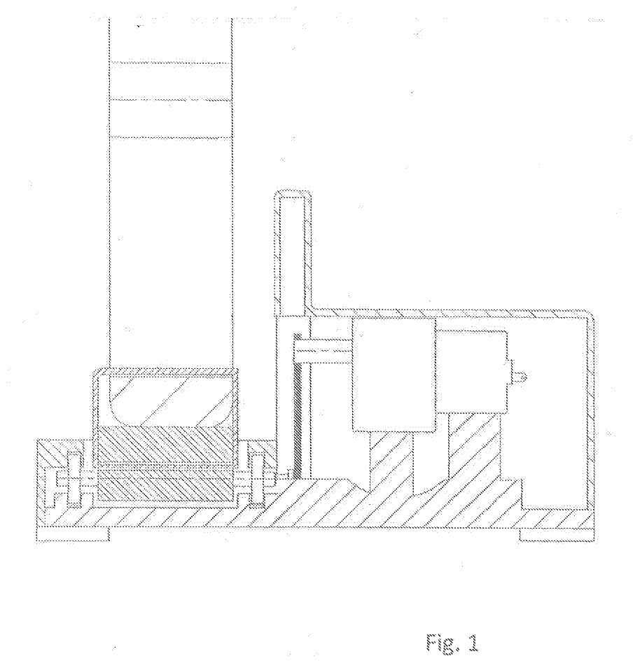

FIGS. 2 and 3 show the cut via device, and

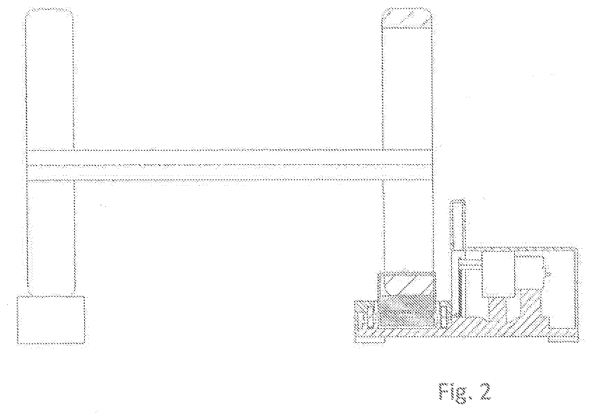

FIG. 4 shows a possible shape of the pad.

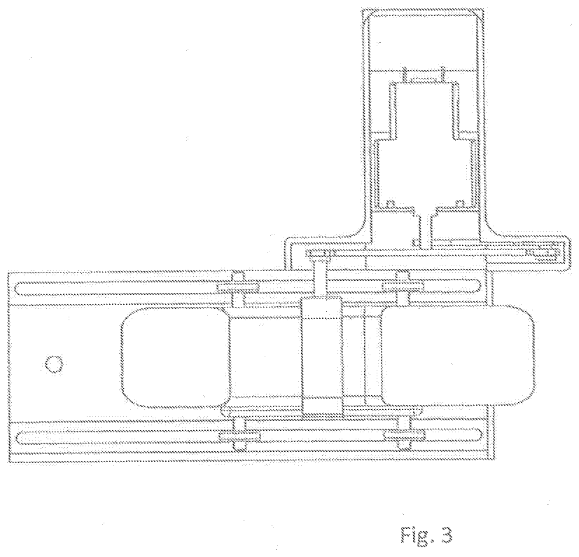

### MODES FOR CARRYING OUT THE INVENTION

As seen from the pictures, the device consists of a base plate 1 in which there are formed rails 2, in which there is placed the travel 3 on the wheels 4. The travel 3 is connected with an electric motor 5 fastened also to the base plate 1, which ensures the movement of the travel 3. The transfer of the rotational movement of the electric motor 5 into linear movement of the reciprocating to the travel is achieved by thanks to the crank mechanism. One side of the crank is rigidly connected with an electric motor 5, the other side is fixed to the travel 3. To the travel 3 there is fixed the wheel 6 of a stroller or crib, using demountable joint 7, namely velcro. An important part of the device are the upper rails 11, fasten from the side to the base plate 1, which prevent from the vertical movement of the travel and thus allow only horizontal movement. The wheels 4 are connected with the travel 3 via a shaft, which is placed in it by using sliding or rolling bearings. The electric motor 5 with accessories is placed, to increase the security, under the cover 8, under which there can be placed also the battery or other batteries for energy supply. Under the second wheel 6 of the stroller or the crib there is inserted a pad 9, in order to ensure flatness. The shape of this pad is linear or varying harmonic (ripples) to provide a variety of additional movements of the stroller, such as the crossing over the obstacle. Under the cover 8 there is placed also the additional electronics for the possibility of changing the travel speed, and for completion of the rocking by music and so on. The basic plate 1 can be fitted with rubber pads 10 to increase friction and better secure the stability of the whole device. The device can be controlled by using the remote control, and/or mobile phone (bluetooth, wifi).

The use of this rocking device is simple. The rocking device is placed on a solid and flat surface (floor, ground). One wheel 6 of the stroller is placed in a travel 3 and secured by using demountable joints 7. Under the second wheel 6 of the stroller there is placed the pad 9 with an irregular surface. The operator turns on the electric motor (manually, by remote control), selects the speed of movement and, thanks to a linear back motion of the travel 3 on the wheels 4 it will rock the stroller. Thanks to the integrated electronics it is possible to change the travel speed, play the music and so on.

### INDUSTRIAL APPLICABILITY

The rocking device according to this technical solution is applicable generally for almost all types of baby strollers and cribs available on the market.

1. A rocking device, especially for strollers and cribs, wherein it consists of a base plate in which there are formed rails, in which there is placed the travel on the wheels which is connected with an electric motor fastened also to the base plate, and which ensures the movement of the travel, where to the travel there is fixed the wheel of a stroller or crib, using demountable joint, and to ensure the linear movement of the travel at least one upper rail is used.

2. The rocking device according to claim 1, wherein the electro motor is driven by the alternating or direct current by the battery/accumulator and is placed on the base plate under the cover.

3. The rocking device according to claim 1, wherein under the second wheel there is placed the pad with flat or rough surface.

4. The rocking device according to claim 1, wherein the wheels are connected with the travel via a shaft, which is placed in it by using sliding or rolling bearings.

5. The rocking device according to claim 1, wherein the basic plate can be fitted with rubber pads to increase friction and better secure the stability.

6. The rocking device according to claim 1, wherein it contains the electronics for changing the rocking speed, setting the time for turning on/turning off of the device, the music player and other accessories which can be controlled by the remote control and/or by the mobile phone (Bluetooth, wifi).
